(19) United States
(12) Patent Application Publication
(10) Pub. No.: US 2018/0248445 A1
(43) Pub. Date: Aug. 30, 2018

(54) ROTOR ASSEMBLY AND STEPPING MOTOR INCLUDING SAME

(71) Applicant: Continental Automotive GmbH, Hannover (DE)

(72) Inventors: Kun CHEN, Wuhu (CN); Tao CHENG, Wuhu (CN)

(73) Assignee: Continental Automotive GmbH, Hannover (DE)

(21) Appl. No.: 15/965,408

(22) Filed: Apr. 27, 2018

Related U.S. Application Data
(63) Continuation of application No. PCT/EP2016/075924, filed on Oct. 27, 2016.

(30) Foreign Application Priority Data
Oct. 30, 2015 (CN) 201510724814.4
Oct. 30, 2015 (CN) 201520851094.3

(51) Int. Cl. H02K 7/00; H02K 5/22; H02K 7/08; H02K 37/14; B60Q 1/124; F16H 25/20

(52) U.S. Cl. CPC H02K 7/003; H02K 5/225; H02K 7/085; F16H 2025/204; B60Q 1/124; F16H 25/20; F16H 2025/2075; H02K 37/14

(57) ABSTRACT

A rotor assembly, which includes a rotor casing (1); a rotor shaft (2) with an external thread, the rotor shaft (2) being installed inside the rotor casing (1); a magnet (3), the magnet (3) being installed outside the rotor casing (1); and a telescopic shaft (4), the telescopic shaft (4) being mounted on the external thread of the rotor shaft (2) via an internal thread on an inner surface of the telescopic shaft. The rotor assembly according to the present device has the advantages of being long, having few components, the manufacturing cost being low, and the linear accuracy being high.

### CROSS-REFERENCE TO RELATED APPLICATIONS

This application claims the benefit of PCT Application PCT/EP2016/075924, filed Oct. 27, 2016, which claims priority to Chinese Patent Application 201510724814.4, filed Oct. 30, 2015, and Chinese Patent Application 201520851094.3, filed Oct. 30, 2015. The disclosures of the above applications are incorporated herein by reference.

### FIELD OF THE INVENTION

The present device relates to the field of automobile parts, in particular to a rotor assembly applied to an adaptive steering headlight of an automobile and a stepping motor including same.

### BACKGROUND OF THE INVENTION

In order to improve the safety of driving operation of an automobile, provided in industry is a system for adaptively controlling the illumination direction of a vehicle light; the system follows a steering angle of a steering wheel and a pitch angle of a vehicle suspension system to perform rotation in the left, right, up and down directions, such that the illumination direction of the vehicle light (especially a headlamp) not only faces in the direction of travel in a straight line, but also may face in the direction in which a driver steers, and the system plays a major role in improving the running safety of the automobile.

In the above system for controlling a vehicle light, a stepping motor (such as a linear stepping motor) is used as a driving device at present in industry; however, as shown in the Chinese authorized patents with publication numbers CN 201674378 U and CN 202300660 U, the structure of the rotor and the output shaft included in the stepping motor serving as a driving device has the following defects: the shaft inserted into the rotor includes a smooth guiding portion located outside the rotor, and a threaded portion located inside the rotor and fitted with the rotor; in this structure, in order to achieve a certain travel, the length of the shaft must be more than double the traversed length, such that the manufacturing cost of the shaft is high, the linear accuracy is hard to ensure, and the overall size of the electric motor is too long.

### SUMMARY OF THE INVENTION

The purpose of the present device is to provide a stepping motor applied to a headlight steering system and a rotor assembly included in same, thereby solving the problem of how to increase the travel of the output shaft in the case where the overall size of the electric motor is constant.

A rotor assembly provided by the present device includes: a rotor casing 1; a rotor shaft 2 with an external thread, the rotor shaft 2 being installed inside the rotor casing 1; a magnet 3, the magnet 3 being installed outside the rotor casing 1; and a telescopic shaft 4, the telescopic shaft 4 being a hollow tube with an internal thread and being installed on the external thread of the rotor shaft 2 via the internal thread on the inner surface of the telescopic shaft.

Preferably, the rotor assembly further includes a bearing 5 installed at the outer periphery of the rotor casing 1.

Preferably, the interior of the rotor casing 1 is of a hollow structure, and the external thread of the rotor shaft 2 is at least partially located in the internal hollow structure of the rotor casing 1.

Preferably, through cooperation with the external thread of the rotor shaft 2, the telescopic shaft 4 is partially or completely rotated into the internal hollow structure of the rotor casing 1.

Preferably, the magnet 3 is an annular magnet, and is fitted round and fixed on a cylindrical outer surface of the rotor casing 1.

Preferably, the outer surface of the telescopic shaft 4 is provided with a guiding groove, the guiding groove extends from one end of the telescopic shaft 4 in the axial direction of the telescopic shaft 4 but does not penetrate through to the other end of the telescopic shaft 4, and there are two guiding grooves which are symmetrically distributed on the outer surface of the telescopic shaft 4.

Preferably, the rotor casing 1 and the rotor shaft 2 are fitted together by injection moulding, and a bare end 21 of the rotor shaft 2 after injection moulding is located outside a closed end of the rotor casing 1.

Preferably, a zigzag structure 22 is formed at the outer periphery of the joint of the rotor shaft 2 and the rotor casing 1.

The present device further provides a stepping motor, including: a stator 6 with a coil wound outside; a rotor assembly installed inside the stator 6; a magnetic guide ring 10 surrounding the outer periphery of the stator 6; an electrical connector 8 for powering the stepping motor; the rotor assembly further includes: a rotor casing 1; a rotor shaft 2 with an external thread, the rotor shaft 2 being installed inside the rotor casing 1; a magnet 3, the magnet 3 being installed outside the rotor casing 1; and a telescopic shaft 4, the telescopic shaft 4 being a hollow tube with an internal thread and being installed in a fitted manner on the external thread of the rotor shaft 2 via the internal thread on the inner surface of the telescopic shaft; and a bearing 5 installed at the outer periphery of the rotor casing 1.

Preferably, the magnet 3 is an annular magnet and is located inside the stator 6, and an outer ring thereof is in a clearance fit with the stator 6.

Preferably, an outer ring of the bearing 5 is pressed into the stator 6.

Preferably, the interior of the rotor casing 1 is of a hollow structure, and the external thread of the rotor shaft 2 is at least partially located in the internal hollow structure of the rotor casing 1.

Preferably, through cooperation with the external thread of the rotor shaft 2, the telescopic shaft 4 is partially or completely rotated into the internal hollow structure of the rotor casing 1.

Preferably, the outer surface of the telescopic shaft 4 is provided with a guiding groove, the guiding groove extends from one end of the telescopic shaft 4 in the axial direction of the telescopic shaft 4 but does not penetrate through to the other end of the telescopic shaft 4.

Preferably, the stepping motor further includes: a front end cover 9 press-fitted into the magnetic guide ring 10 and provided with a protrusion structure, the protrusion structure being at least partially located inside the guiding groove on the telescopic shaft 4, thereby preventing rotation of the telescopic shaft 4 and guiding the telescopic shaft 4 in the axial direction.

Preferably, the rotor casing 1 and the rotor shaft 2 are fitted together by injection moulding, and a bare end 21 of the rotor shaft 2 after injection moulding is located outside the closed end of the rotor casing 1.

Preferably, a positioning hole 61 is formed on the stator 6, and the bare end 21 of the rotor shaft 2 is at least partially located in the positioning hole 61.

Preferably, the stepping motor further includes: a coupling ball 7 installed at an output end of the telescopic shaft 4; an O-ring 11, the O-ring 11 being arranged on the front end cover 9 in a surrounding manner; and a rear end cover 12, the rear end cover 12 being press-fitted onto the electrical connector 8.

Preferably, a zigzag structure 22 is formed at the outer periphery of the joint of the rotor shaft 2 and the rotor casing 1.

Compared with the prior art, since the present device uses a novel structural design of a rotor assembly and a stepping motor, in the case where the overall external size of the electric motor is constant, the telescopic shaft (output shaft) may provide a longer travel, and at the same time, the manufacturing cost is reduced, and the linear accuracy is ensured.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention

### BRIEF DESCRIPTION OF THE DRAWINGS

The drawings constituting a part of the present invention are used to provide further understanding of the present device; schematic embodiments and illustrations thereof of the present device are used to explain the present device, and do not form an inappropriate definition of the present device. In the drawings:

FIG. 1 is an exploded view of various parts of the rotor assembly of the present device;

FIG. 2 is a sectional view of the rotor assembly shown in FIG. 1 after being assembled;

FIG. 3A is a perspective schematic view of a telescopic shaft shown in FIG. 1;

FIG. 3B is a front view of the telescopic shaft shown in FIG. 3A;

FIG. 3C is a left view of FIG. 3B; FIG. 3D is a sectional view of FIG. 3B;

FIG. 4 is a sectional view of a stepping motor including the rotor assembly shown in FIG. 1;

FIG. 5A is a perspective schematic view of a front end cover shown in FIG. 4;

FIG. 5B is a top view of the front end cover shown in FIG. 5A; and

FIG. 6 is a perspective schematic view of the stepping motor shown in FIG. 4 after being assembled.

### DETAILED DESCRIPTION OF THE PREFERRED EMBODIMENT

The following description of the preferred embodiment(s) is merely exemplary in nature and is in no way intended to limit the invention, its application, or uses.

The rotor assembly and the stepping motor including same of the present device will be described below with reference to the accompanying drawings and the embodiments.

### Embodiment 1

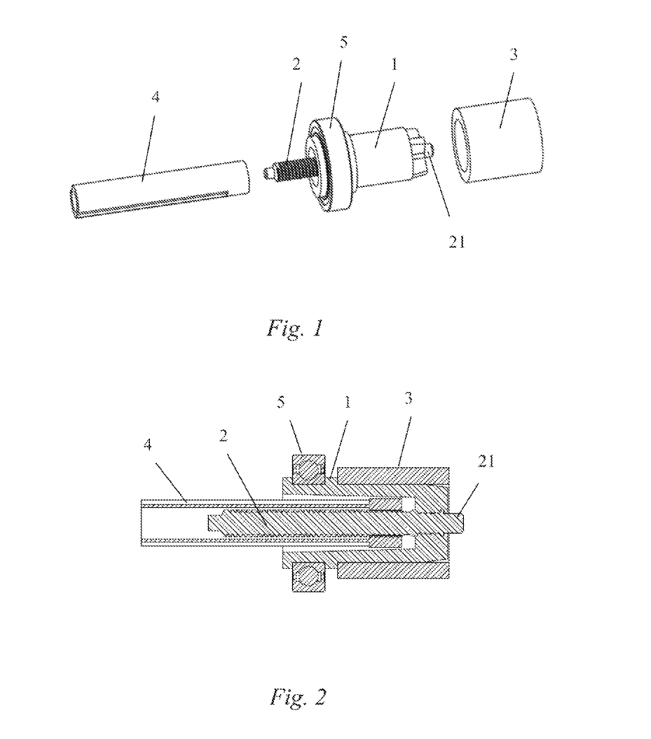

FIG. 1 is an exploded view of various parts of the rotor assembly of the present device, FIG. 2 is a sectional view of the rotor assembly shown in FIG. 1 after being assembled, and as shown in FIG. 1 and FIG. 2, the rotor assembly specifically consists of the following parts: a rotor casing 1; a rotor shaft 2 with an external thread, the rotor shaft 2 being installed inside the rotor casing 1; a magnet 3, the magnet 3 being installed outside the rotor casing 1; and a telescopic shaft 4, the telescopic shaft 4 being a hollow tube with an internal thread and being installed on the external thread of the rotor shaft 2 via the internal thread on the inner surface of the telescopic shaft.

Preferably, the rotor casing 1 has a structure similar to a hollow cylindrical teacup, the material thereof is selected randomly according to practical requirements, and in the present embodiment, in order to reduce the weight of the rotor assembly, the material of the rotor casing 1 is preferably plastics; the rotor shaft 2 and the rotor casing 1 are fixedly fitted together by means of injection moulding, the external thread of the rotor shaft 2 is completely or partially located in an internal hollow structure of the rotor casing 1, a bare end 21 of the rotor shaft 2 after the injection moulding is located outside a closed end of the rotor casing 1 (the rotor shaft 2 is inserted into and penetrates the bottom part of the rotor casing 1 which is similar to the closed end of the teacup), and furthermore, as shown in FIG. 2, in order to guarantee the connection force between the rotor casing 1 and the rotor shaft 2 after the injection moulding, a zigzag structure 22 is designed and formed at the outer periphery of the joint of the rotor shaft 2 and the rotor casing 1.

Preferably, the magnet 3 is an annular magnet, which is fixedly mounted on a cylindrical outer surface of the rotor casing 1 by means of interference or injection moulding.

Preferably, the telescopic shaft 4 is of a hollow tubular plastic structure with an internal thread and is mounted on the external thread of the rotor shaft 2 via the internal thread on the inner surface thereof so that a rotary motion of the rotor shaft 2 is converted into a linear motion of the telescopic shaft 4. Furthermore, through cooperation with the external thread of the rotor shaft 2, the telescopic shaft 4 is partially or completely rotated into the internal hollow structure of the rotor casing 1.

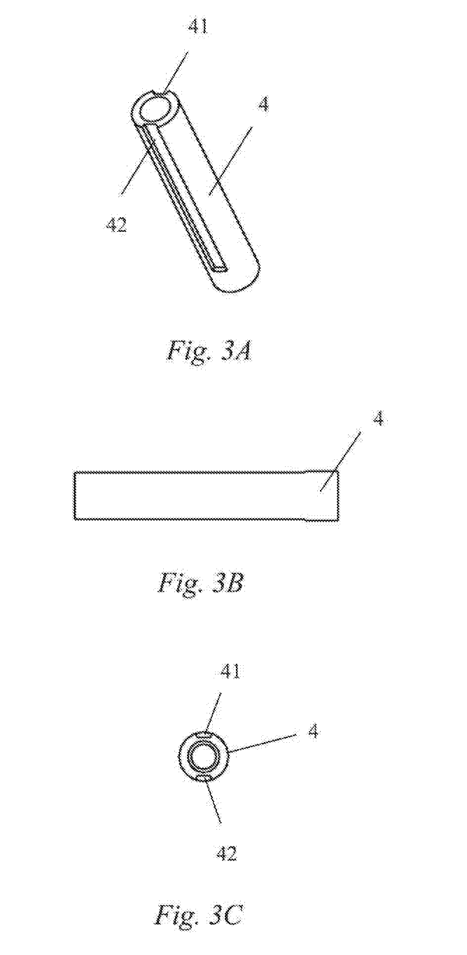

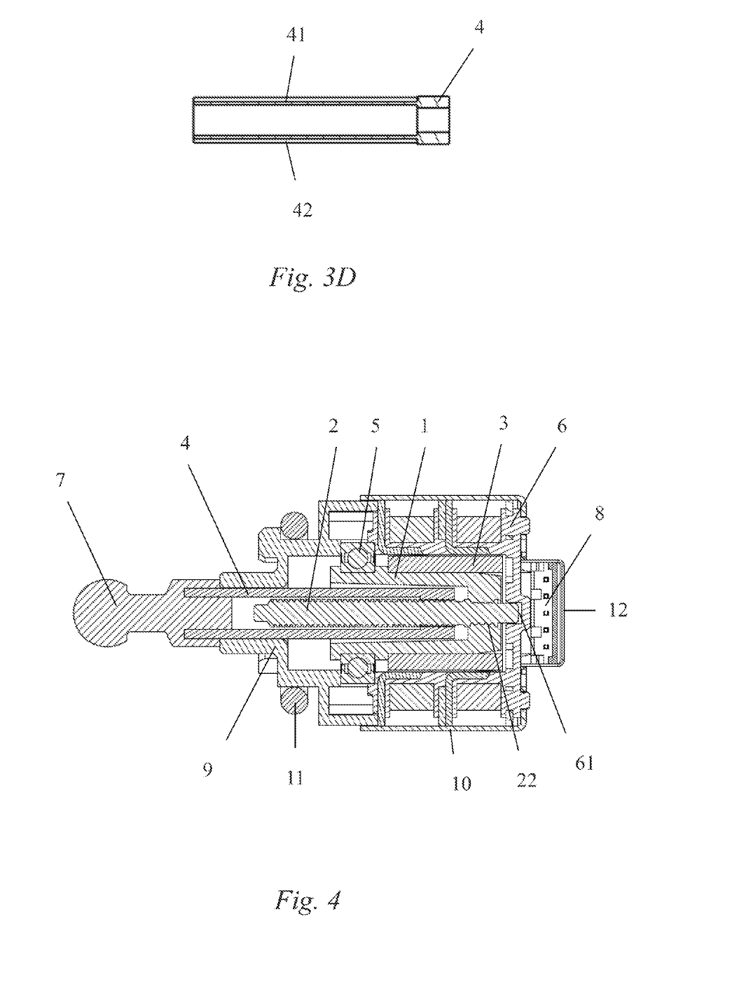

Preferably, as shown in FIGS. 3A to 3D, an outer surface of the telescopic shaft 4 is provided with a guiding groove or guiding protrusion (the drawings do not provide an example of the guiding protrusion), and the guiding groove or guiding protrusion extends from one end of the telescopic shaft 4 in the axial direction of the telescopic shaft 4 but does not penetrate through to the other end of the telescopic shaft 4. The number of the guiding groove(s) or guiding protrusion(s) is not defined, and in the present embodiment, there are two the guiding grooves or guiding protrusions (structures 41 and 42 shown in the drawings are guiding grooves), and the two guiding grooves or guiding protrusions are distributed symmetrically on the outer surface of the telescopic shaft 4.

Preferably, as shown in FIG. 1 and FIG. 2, in order to enable the above-mentioned rotor assembly to be fixedly mounted in the motor better, the rotor assembly also includes a bearing 5 mounted at the outer periphery of the rotor casing 1, and the bearing 5 is fixedly mounted at the outer periphery of the rotor casing 1 by means of injection moulding, cold pressing or interference.

The above-mentioned rotor assembly structure is mainly applied to the stepping motor, and cooperates with other components such as a stator and a coil to control a system such as an automobile steering headlight system or an air intake/exhaust system.

### Embodiment 2

The present embodiment will describe a stepping motor which has a compact structure and a long travel, and the stepping motor includes the rotor assembly as described in embodiment 1.

FIG. 4 is a sectional view of the stepping motor including the rotor assembly as shown in FIG. 1 and FIG. 2; as shown in FIG. 4, the stepping motor described in the present embodiment includes the following structures: a stator 6 with a coil wound outside; a rotor assembly installed inside the stator 6; a magnetic guide ring 10 surrounding the outer periphery of the stator 6; an electrical connector 8 for powering the stepping motor; wherein the rotor assembly further includes: a rotor casing 1; a rotor shaft 2 with an external thread, the rotor shaft 2 being installed inside the rotor casing 1; a magnet 3, the magnet 3 being installed outside the rotor casing 1; and a telescopic shaft 4, the telescopic shaft 4 being a hollow tube with an internal thread and being installed in a fitted manner on the external thread of the rotor shaft 2 via the internal thread on the inner surface of the telescopic shaft; and a bearing 5 mounted at the outer periphery of the rotor casing 1, the bearing 5 is fixedly mounted at the outer periphery of the rotor casing 1 by means of injection moulding, cold pressing or interference.

Preferably, the magnet 3 is an annular magnet, which is located in the stator 6, an outer ring thereof being in clearance fit with the stator 6.

Preferably, an outer ring of the bearing 5 is press-fitted (for example, press-fitted with interference) into the stator 6 so as to support the above-mentioned rotor assembly.

Preferably, the rotor casing 1 has a structure similar to a hollow cylindrical teacup, the material thereof is selected randomly according to practical requirements, and in the present embodiment, in order to reduce the weight of the rotor assembly, the material of the rotor casing 1 is preferably plastics; and the rotor shaft 2 and the rotor casing 1 are fixedly fitted together by means of injection moulding, and the external thread of the rotor shaft 2 is completely or partially located in an internal hollow structure of the rotor casing 1.

Preferably, the telescopic shaft 4 is a hollow tubular plastic structure with an internal thread and is mounted on the external thread of the rotor shaft 2 via the internal thread on the inner surface of the telescopic shaft so that a rotary motion of the rotor shaft 2 is converted into a linear motion of the telescopic shaft 4. Furthermore, by means of cooperation with the external thread of the rotor shaft 2, the telescopic shaft 4 is partially or completely rotated into the internal hollow structure of the rotor casing 1.

Preferably, as shown in FIGS. 3A to 3D, an outer surface of the telescopic shaft 4 is provided with a guiding groove, and the guiding groove extends from one end of the telescopic shaft 4 in the axial direction of the telescopic shaft 4 but does not penetrate through to the other end of the telescopic shaft 4. The number of the guiding groove(s) is not defined, and in the present embodiment, there are preferably two guiding grooves (structures 41 and 42 shown in the drawings), and the two guiding grooves are distributed symmetrically on the outer surface of the telescopic shaft 4. Alternatively, if no guiding groove is formed on the outer surface of the telescopic shaft 4, the guiding protrusion (the drawings do not provide an example) may realize the guiding function, and the guiding protrusion also extends from one end of the telescopic shaft 4 in the axial direction of the telescopic shaft 4 but does not penetrate through to the other end of the telescopic shaft 4. The number of the guiding protrusion(s) is not defined, but preferably is two, and the two guiding protrusions are distributed symmetrically on the outer surface of the telescopic shaft 4.

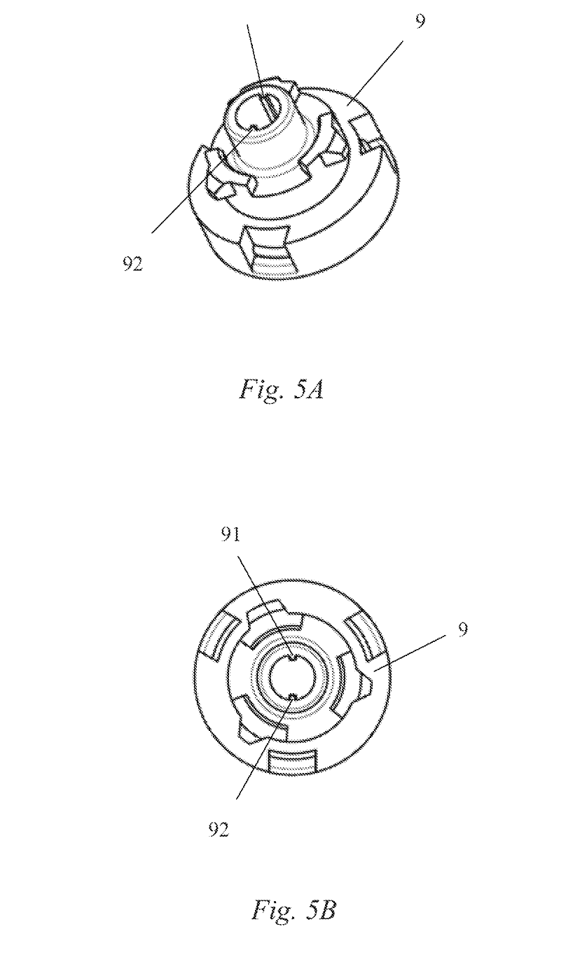

Preferably, as shown in FIGS. 5A and 5B, the stepping motor also includes the front end cover 9 which is press-fitted into the magnetically conductive ring 10 and is provided with a protruding structure, and the protruding structure is at least partially located in the guiding groove on the telescopic shaft 4 so as to prevent the telescopic shaft 4 from rotating and guide the telescopic shaft 4 in the axial direction. In the present embodiment, two protruding structures (91 and 92) which are distributed symmetrically are included in the front end cover 9, and are located in the guiding grooves 41 and 42, to axially guide and restrict the positioning of the telescopic shaft 4. Alternatively, when the guiding structure on the telescopic shaft 4 is a guiding protrusion, in order to cooperate with the guiding protrusion to guide, a groove structure is formed on the front end cover 9 (the drawings do not provide an example); the groove structure at least partially encloses the guiding protrusion on the telescopic shaft 4 so as to prevent the telescopic shaft 4 from rotating and guide the telescopic shaft 4 in the axial direction. In the same way, the number of the protrusion(s) on the front end cover 9 may be two, and the protrusions are distributed symmetrically in the front end cover 9.

Furthermore, the front end cover 9 is in clearance fit with the magnetically conductive ring 10, in order to effectively fix and lock the whole motor; the magnetically conductive ring 10 is provided with a plurality of jaw piece structures, and these jaw piece structures are bent and then pressed onto the front end cover 9.

Preferably, as shown in FIG. 4, the rotor casing 1 and the rotor shaft 2 are fitted together by means of injection moulding, the bare end 21 of the rotor shaft 2 after the injection moulding is located outside the closed end of the rotor casing 1 (the rotor shaft 2 is inserted into and penetrates through a bottom part of the rotor casing 1 which is similar to a closed end of a teacup), and furthermore, in order to guarantee the connection force between the rotor casing 1 and the rotor shaft 2 after the injection moulding, the zigzag structure 22 is designed and formed at the outer periphery of the joint of the rotor shaft 2 and the rotor casing 1.

Preferably, as shown in FIG. 4, a positioning hole 61 is formed on the stator 6, the bare end 21 of the rotator shaft 2 is at least partially located in the positioning hole 61, such that the positioning hole 61 may replace a traditional rear bearing to support the rotor shaft 2, and cooperate with the bearing 5 to support the rotor shaft 2 at both ends. In addition, in order to reduce friction between the bare end 21 and the positioning hole 61, grease is smeared on the bare end 21 or the positioning hole 61.

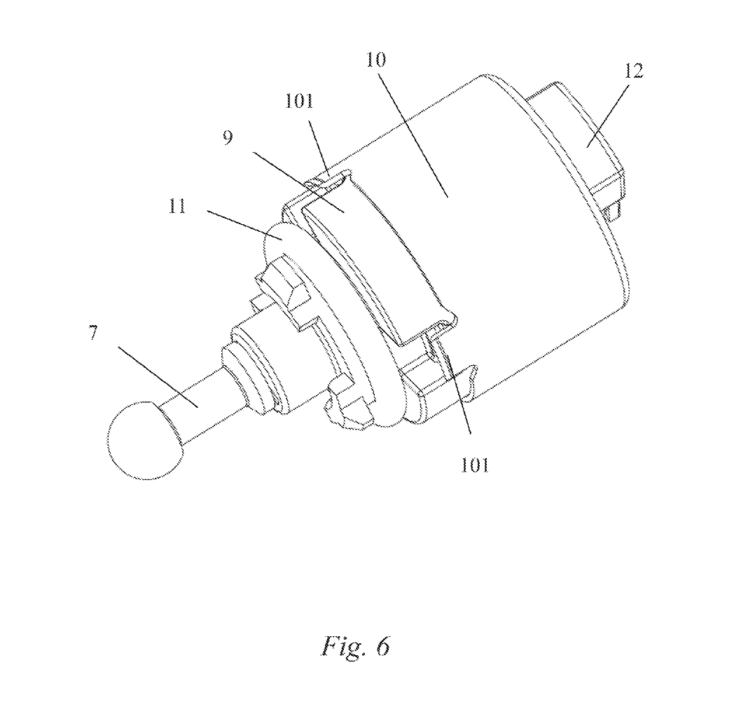

Preferably, as shown in FIG. 4 and FIG. 6, the stepping motor also includes a coupling ball 7 mounted on an output end of the telescopic shaft 4, wherein the coupling ball 7 may be fixedly mounted on the telescopic shaft 4 by hot riveting, adhesive dispensing or inserting a pin laterally.

Preferably, as shown in FIG. 6, the stepping motor also includes an O-ring 11, wherein the O-ring 11 is provided on the front end cover 9 in a surrounding manner, and when the stepping motor is mounted in a customer interface, the O-ring 11 is pressed and deforms so as to provide a pre-tensioning force for the mounting.

Preferably, as shown in FIG. 6, the stepping motor also includes a rear end cover 12, wherein the rear end cover 12 is press-fitted onto the electrical connector 8.

The working manner and principle of the above-mentioned stepping motor are as follows: when the stator 6 wound with the coil supplies power via a pin connector 8, magnetic field loops are formed between the stator 6, the magnetically conductive ring 10 and the annular magnet 3 to generate a torque which drives the rotor casing 1 to rotate so as to drive the rotor shaft 2 to rotate, and due to the cooperation of the threads, the telescopic shaft 4 converts the rotational motion into linear motion, driving the coupling ball 7 to move back and forth along the axial direction of the telescopic shaft 4.

Although the present device has been disclosed above in terms of the preferred embodiments, the present device is not limited to this. Any modification or amendment made by any person skilled in the art without departing from the spirit and scope of the present device should be included in the protection scope of the present device, and therefore the protection scope of the present device shall be the scope defined in the claims.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A rotor assembly, characterized by comprising:
a rotor casing (1);
a rotor shaft (2) with an external thread, the rotor shaft (2) being installed inside said rotor casing (1);
a magnet (3), the magnet (3) being installed outside said rotor casing (1); and
a telescopic shaft (4), the telescopic shaft (4) being a hollow tube with an internal thread and being installed on the external thread of said rotor shaft (2) via the internal thread on the inner surface of the telescopic shaft.

2. The rotor assembly of claim 1, said rotor assembly further comprising a bearing (5) installed at the outer periphery of said rotor casing (1).

3. The rotor assembly of claim 1, the interior of said rotor casing (1) further comprising a hollow structure, wherein the external thread of said rotor shaft (2) is at least partially located in the internal hollow structure of said rotor casing (1).

4. The rotor assembly of claim 3, wherein, through cooperation with the external thread of said rotor shaft (2), said telescopic shaft (4) is partially rotated into the internal hollow structure of said rotor casing (1).

5. The rotor assembly of claim 3, wherein, through cooperation with the external thread of said rotor shaft (2), said telescopic shaft (4) is completely rotated into the internal hollow structure of said rotor casing (1).

6. The rotor assembly of claim 3, wherein said rotor casing (1) and said rotor shaft (2) are fitted together by injection molding, such that a bare end (21) of said rotor shaft (2) is located outside a closed end of said rotor casing (1).

7. The rotor assembly of claim 1, said magnet (3) further comprising an annular magnet, wherein said annular magnet is fitted round and fixed on a cylindrical outer surface of said rotor casing (1).

8. The rotor assembly of claim 1, the outer surface of said telescopic shaft (4) further comprising at least one guiding groove.

9. The rotor assembly of claim 8, wherein said at least one guiding groove extends from one end of said telescopic shaft (4) in the axial direction of said telescopic shaft (4).

10. The rotor assembly of claim 8, said at least one guiding groove further comprising at least two guiding grooves , wherein said at least two guiding grooves are symmetrically distributed on the outer surface of said telescopic shaft (4).

11. The rotor assembly of claim 1, the outer surface of said telescopic shaft (4) further comprising at least one guiding protrusion.

12. The rotor assembly of claim 11, wherein said at least one guiding protrusion extends from one end of said telescopic shaft (4) in the axial direction of said telescopic shaft (4).

13. The rotor assembly of claim 11, said at least one guiding protrusion (4) further comprising at least two guiding protrusions, wherein said at least two guiding protrusions are symmetrically distributed on the outer surface of said telescopic shaft (4).

14. The rotor assembly of claim 1, further comprising a zigzag structure 22 formed at the outer periphery of the joint of said rotor shaft (2) and said rotor casing (1).

15. A stepping motor, comprising:
a stator (6) with a coil wound outside;
a rotor assembly installed inside said stator (6);
a magnetic guide ring (10) surrounding the outer periphery of said stator (6);
an electrical connector (8) for powering the stepping motor;
said rotor assembly further comprising:
a rotor casing (1);
a rotor shaft (2) with an external thread, the rotor shaft (2) being installed inside said rotor casing (1);
a magnet (3), the magnet (3) being installed outside said rotor casing (1); and
a telescopic shaft (4), the telescopic shaft (4) being a hollow tube with an internal thread and being installed in a fitted manner on the external thread of said rotor shaft (2) via the internal thread on the inner surface of the telescopic shaft; and
a bearing (5) installed at the outer periphery of said rotor casing (1).

16. The stepping motor of claim 15, said magnet (3) further comprising an annular magnet, wherein said annular magnet is located inside said stator (6) and an outer ring thereof is in a clearance fit with said stator (6).

17. The stepping motor of claim 15, wherein the outer ring of said bearing (5) is press-fitted into said stator (6).

18. The stepping motor of claim 15, wherein the interior of said rotor casing (1) is of a hollow structure, and the external thread of said rotor shaft (2) is at least partially located in the internal hollow structure of said rotor casing (1).

19. The stepping motor of claim 18, wherein, through cooperation with the external thread of said rotor shaft (2), said telescopic shaft (4) is partially rotated into the internal hollow structure of said rotor casing (1).

20. The stepping motor of claim 18, wherein, through cooperation with the external thread of said rotor shaft (2), said telescopic shaft (4) is completely rotated into the internal hollow structure of said rotor casing (1).

21. The stepping motor of claim 15, the outer surface of said telescopic shaft (4) further comprising a guiding groove, wherein said guiding groove extends from one end of said telescopic shaft (4) in the axial direction of said telescopic shaft (4).

22. The stepping motor of claim 21, said stepping motor further comprising:
a front end cover (9) press-fitted into said magnetic guide ring (10); and
a protrusion structure;
wherein said protrusion structure is at least partially located inside the guiding groove on said telescopic shaft (4), preventing rotation of said telescopic shaft (4) and guiding said telescopic shaft (4) in the axial direction.

23. The stepping motor of claim 22, said stepping motor further comprising an O-ring (11), wherein the O-ring (11) is arranged on said front end cover (9) in a surrounding manner.

24. The stepping motor of claim 15, the outer surface of said telescopic shaft (4) further comprising a guiding protrusion, wherein said guiding protrusion extends from one end of said telescopic shaft (4) in the axial direction of said telescopic shaft (4).

25. The stepping motor of claim 23, said stepping motor further comprising:
a front end cover (9) press-fitted into said magnetic guide ring (10); and
a groove structure,
wherein the groove structure at least partially encloses the guiding protrusion on said telescopic shaft (4), thereby preventing rotation of said telescopic shaft (4) and guiding said telescopic shaft (4) in the axial direction.

26. The stepping motor of claim 25, said stepping motor further comprising an O-ring (11), wherein the O-ring (11) is arranged on said front end cover (9) in a surrounding manner.

27. The stepping motor of claim 15, wherein said rotor casing (1) and said rotor shaft (2) are fitted together by injection molding, such that a bare end (21) of said rotor shaft (2) is located outside a closed end of said rotor casing (1).

28. The stepping motor of claim 27, further comprising a positioning hole (61) formed on said stator (6), wherein the bare end (21) of said rotor shaft (2) is at least partially located in the positioning hole (61).

29. The stepping motor of claim 15, said stepping motor further comprising a coupling ball (7) installed at an output end of said telescopic shaft (4).

30. The stepping motor of claim 15, said stepping motor further comprising a rear end cover (12), the rear end cover (12) being press-fitted onto said electrical connector (8).

31. The rotor assembly of claim 15, further comprising a zigzag structure 22 formed at the outer periphery of the joint of said rotor shaft (2) and said rotor casing (1).
